(19) United States
(12) Patent Application Publication
(10) Pub. No.: US 2014/0077930 A1
(43) Pub. Date: Mar. 20, 2014

(54) REMOTE KEYLESS ENTRY TRANSMITTER WITH REPEATING TRANSMISSION OF A MESSAGE

(71) Applicants: JEROME COUDRE, BAILLY-ROMAINVILLERS (FR); CRAIG A. TIEMAN, WESTFIELD, IN (US)

(72) Inventors: JEROME COUDRE, BAILLY-ROMAINVILLERS (FR); CRAIG A. TIEMAN, WESTFIELD, IN (US)

(73) Assignee: DELPHI TECHNOLOGIES, INC., TROY, MI (US)

(21) Appl. No.: 13/618,059

(22) Filed: Sep. 14, 2012

(51) Int. Cl. G08C 19/00

(52) U.S. Cl. CPC G08C 19/00
USPC 340/5.64

(57) ABSTRACT

A remote keyless entry (RKE) system for a vehicle. The system includes a RKE receiver configured to be installed on a vehicle, and a nomadic device equipped with an RKE transmitter configured to transmit autonomously a RKE message repetitiously in response to an initiation command. The nomadic device is able to be pre-armed the nomadic device while outside of the communication range of the vehicle to transmit periodically, repeatedly, or continuously the RKE message. Then, an operator can put the nomadic device in a pocket and proceed to within the communication range and, for example, have the trunk open without having to manually operate the nomadic device while within the communication range.

### TECHNICAL FIELD OF INVENTION

This disclosure generally relates to a remote keyless entry (RKE) system, and more particularly relates to a RKE transmitter configured to transmit autonomously a RKE message repetitiously in response to an initiation command.

### BACKGROUND OF INVENTION

Many vehicles are equipped with remote keyless entry (RKE) systems that require an operator to press a button on a nomadic device such as a key fob or personal communication device while the nomadic device is within a relatively short communication range of the vehicle, within fifty meters (50 m) for example. However, instances arise that make it difficult for the operator to press the button after the operator has approached the vehicle to within the communication range. For example, the operator may be carrying several objects such as bags of groceries that make it inconvenient or impossible for the operator to press the button without setting the objects down. Furthermore, rain or other considerations may lead to damage of the objects if the operator does set the objects down in order to free up a hand to operate the nomadic device.

### SUMMARY OF THE INVENTION

Described herein is a nomadic device that can be activated to transmit autonomously a remote keyless entry (RKE) message repetitiously so that, for example, the operator can operate or pre-arm the nomadic device when outside the communication range and before the operator's hands are fully utilized for carrying the objects described above.

In accordance with one embodiment, a nomadic device configured to communicate with a remote keyless entry (RKE) receiver of a vehicle is provided. The nomadic device includes a RKE transmitter configured to transmit autonomously a RKE message repetitiously in response to an initiation command.

In another embodiment, a remote keyless entry (RKE) system for a vehicle is provided. The system includes a RKE receiver and a nomadic device. The RKE receiver configured to be installed on a vehicle. The nomadic device is equipped with an RKE transmitter configured to transmit autonomously a RKE message repetitiously in response to an initiation command.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a remote keyless entry (RKE) system in accordance with one embodiment; and

FIG. 2 is a flowchart of a method for operating a nomadic device that is part of the system of FIG. 1 in accordance with one embodiment.

### DETAILED DESCRIPTION

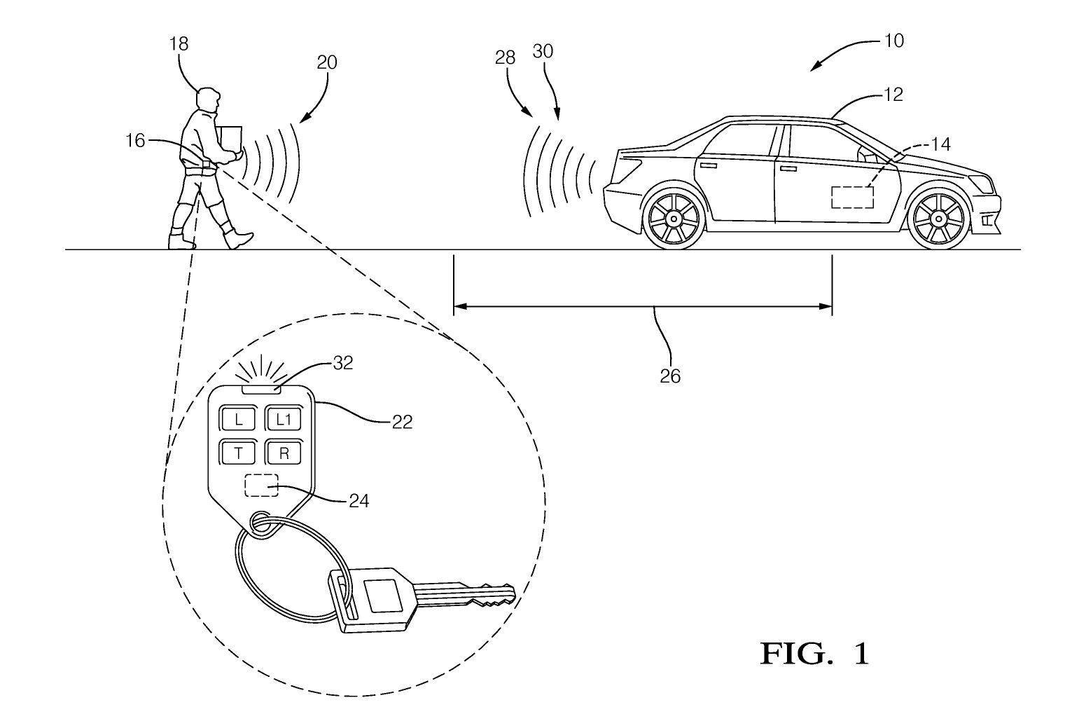

FIG. 1 illustrates a non-limiting example of a remote keyless entry (RKE) system, hereafter the system 10, for a vehicle 12. In general, the vehicle 12 is equipped with a RKE receiver 14 that is generally configured to be installed on the vehicle 12. The RKE receiver 14 is coupled to the electrical system of the vehicle 12 so that the RKE receiver can activate a trunk latch release of the vehicle 12, unlock or open the doors of the vehicle 12, or start the engine of the vehicle 12, for example. A nomadic device 16 carried by an operator 18 preparing to use the vehicle 12 transmits a RKE signal or a RKE message 20 to the RKE receiver 14 to indicate which action (e.g. unlock door, open trunk) should be performed.

The nomadic device 16 is illustrated in this non-limiting example as a key fob 22. Alternatively, the nomadic device 16 could be a smart phone, tablet, or other such portable personal communication device. In order to overcome the problems described above where the operator 18 is unable to operate conveniently the nomadic device 16 because the operator's hands are full, the nomadic device 16 is equipped with a RKE transmitter 24 configured to transmit autonomously a RKE message repetitiously in response to an initiation command. As used herein, to transmit autonomously a RKE message repetitiously means that the RKE transmitter 24 will repeatedly, periodically, or continuously transmit the RKE message once an initiation command is entered, and will continue to do so until some criteria is met that stops the RKE transmitter 24 from transmitting.

The initiation command may be issued or entered by the operator pressing one or more buttons on the key fob 22. This feature advantageously allows the operator 18 to ‘pre-arm’ the nomadic device 16 before the operator's hands are full. For example, if the operator 18 is preparing to carry a package from a store to the vehicle 12, the operator 18 can simultaneously press the trunk release button T and the repeat message button R in order to issue an initiation command before the operator picks up the package. In response to this initiation command, the nomadic device 16 will continuously or repeatedly transmit an RKE message 20 to open the trunk, even though the operator 18 is initially too far away from the vehicle 12 for the RKE message 20 to be received by the RKE receiver. When the operator 18 approaches the vehicle 12, and approaches within a communication range 26 of the system 10, the trunk will open without the operator having to set the package aside to operate manually the nomadic device 16, in this example the key fob 22. Such a nomadic device 16, key fob 22, and RKE transmitter 24 are distinguished from other know comparable devices because for those comparable devices to repeatedly or continuously transmit an RKE message, a button on the nomadic device must be manually pressed repeatedly or held pressed continuously for a transmitter to transmit any signal similar to that output by the RKE transmitter 24 repeatedly transmitting the RKE message 20.

The RKE transmitter 24 may include a processor such as a microprocessor or other control circuitry as should be evident to those in the art. The RKE transmitter 24 may include memory, including non-volatile memory, such as electrically erasable programmable read-only memory (EEPROM) for storing one or more routines, thresholds and captured data. The one or more routines may be executed by the processor to perform steps for determining if an initiation command or other signals received by the RKE transmitter 24 indicate when to start or stop the automated transmission of the RKE message 20 as described herein.

It may be preferable for the RKE transmitter 24 to be configured to transmit autonomously the RKE message 20 repetitiously at a repetition rate in response to the initiation command. Periodically transmitting the RKE message 20 may be preferable to continuously transmitting the RKE message 20 as it will conserve battery power of the nomadic device. The repetition rate should be fast enough so that the operator 18 does not need to wait for the truck of the vehicle to open if the operator walks quickly toward the vehicle 12, and slow enough to conserve as much battery power as possible. A suitable repetition rate may be for the RKE transmitter 24 to transmit the RKE message once every two seconds.

It may be preferable for the RKE transmitter 24 to be configured to transmit autonomously the RKE message repetitiously for a time interval in response to the initiation command. Such a feature may be advantageous to prevent unnecessary battery power usage if, for example, the operator 18 is prevented from traveling to the vehicle, or a suitable combination of buttons are pressed accidently unbeknownst to the operator 18.

It may be advantageous for the nomadic device 16 to be equipped with an indicator 32, such as a light or beeper, that is activated to indicate that the RKE message 20 is being transmitted. Being so equipped will help the operator determine easily that a proper initiation command has been issued, and so the RKE transmitter 24 is in fact transmitting an RKE message 20. If the time interval described above expires, the RKE transmitter 24 may stop transmitting the RKE message.

The RKE receiver 14 may be equipped with a secondary transmitter (not shown) configured to transmit a message-received signal 28 in response to receiving the RKE message 20 from the nomadic device 16, and the nomadic device 16 may be equipped with a nomadic receiver (not shown) configured to receive the message-received signal 28 from the secondary transmitter installed in the vehicle 12. Configuring the RKE receiver 14 and the nomadic device 16 in this manner provides means whereby the RKE transmitter 24 may cease to transmit repetitiously the RKE message in order to conserve battery power.

The RKE receiver 14 may be equipped with a secondary transmitter (not shown) configured to transmit an identification-request signal 30 in response to receiving the RKE message 20, and the nomadic device 16 may be equipped with a nomadic receiver (not shown) configured to receive the identification-request signal 30 from the vehicle. Accordingly, the RKE transmitter 24 may be further configured to transmit an identification code as part of the RKE message 20 in response to the identification-request signal 30. Configuring the RKE receiver 14 and the nomadic device 16 in this manner provides means whereby vehicle security is enhanced by thwarting attempts to use relay techniques to gain unauthorized access to the vehicle 12.

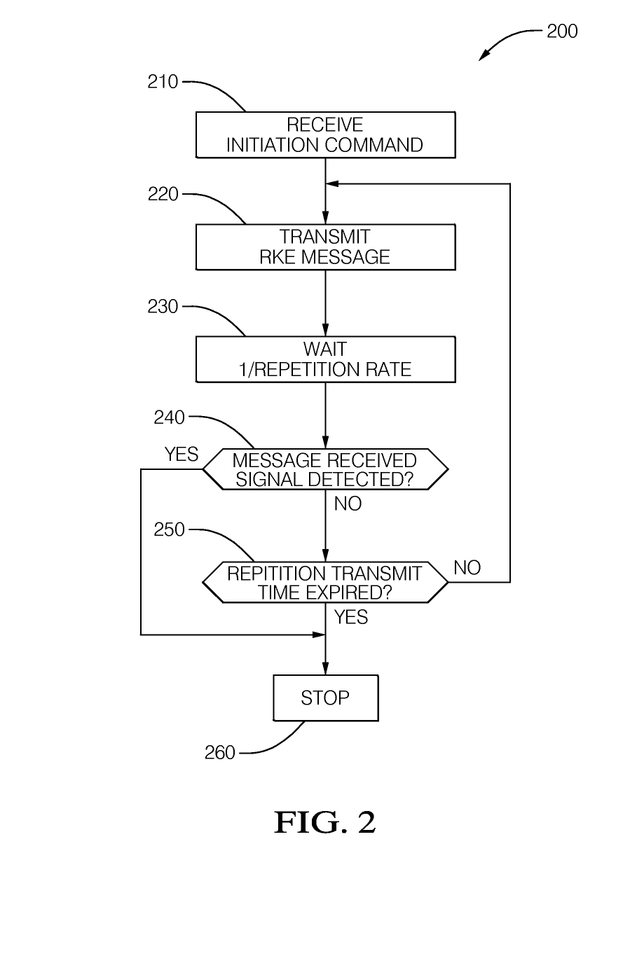

FIG. 2 illustrates a non-limiting example of a method 200 of operating a nomadic device 16. Some of the steps may be replaced by other steps, and some of the steps are optional. Therefore, it is recognized that a different arrangement of steps could be used to operate suitably the RKE transmitter 24 to transmit autonomously a RKE message 20 repetitiously in response to an initiation command.

Step 210, RECEIVE INITIATION COMMAND, may include the RKE transmitter or other suitable electronics in the key fob 22 detecting that one or more buttons (L, U, T, R) are being pressed, and if a proper combinations of buttons are pressed, the method 200 proceeds to step 220.

Step 220, TRANSMIT RKE MESSAGE, may include the RKE transmitter 24 transmitting a RKE message 20 that includes a code or sequence of numbers indicative of an action desired by the operator 18, opening the trunk of the vehicle 12 for example. If the RKE transmitter 24 is configured to transmit the RKE message 20 periodically, the RKE transmitter 24 may be turned off after the RKE message is transmitted, and the method 200 proceeds to step 230. If the RKE transmitter 24 is configured to transmit the RKE message 20 continuously, step 230 may be skipped so the method 200 proceeds directly to Step 240.

Step 230, WAIT 1/REPETITION RATE, may include waiting for one period of the repetition rate. For example, if the repetition rate is one half Hertz (0.5 Hz), then the wait time will be about two seconds (2 s).

Step 240, MESSAGE RECEIVED SIGNAL DETECTED?, is an optional step that may include detecting a message-received signal 28 or an identification-request signal 30 transmitted from the vehicle 12 by the secondary transmitter (not shown). If YES, a message-received signal 28 or an identification-request signal 30 is detected, the RKE transmitter 24 can stop transmitting the RKE message 20 so the method proceeds to step 260. If NO, the RKE transmitter should continue to transmit the RKE message 20, the method 200 proceeds to step 240.

Step 250, REPETITION TRANSMIT TIME EXPIRED?, may include operating a timer (not shown) within the nomadic device 16 so that the battery is not unnecessarily run down. For example, the timer may be used to allow the RKE transmitter 24 to transmit for a suitable amount of time for the operator 18 to walk from a store into a large parking lot, ten (10) minutes for example. Alternatively, if the RKE message 20 is being transmitted periodically, the number of times the RKE message 20 is transmitted could be counted and terminated after a predetermined number of transmissions, three hundred (300) transmissions with a repetition rate is 0.5 Hz for example. If YES, the predetermined number of transmissions has been transmitted, the RKE transmitter 24 can stop transmitting the RKE message 20 so the method proceeds to step 260. If NO, the RKE transmitter should continue to transmit the RKE message 20, the method 200 returns to step 220.

Step 260, STOP, would stop the RKE transmitter 24 from transmitting, and may include activating the indicator 32 in a manner effective to inform the operator 18 that the nomadic device 16 has stopped transmitting the RKE message 20.

Accordingly, a remote keyless entry (RKE) system (the system 10), a nomadic device 16, and a method 200 of operating a nomadic device 16 is provided. The nomadic device 16 is configured so the operator can initiate repetitious transmission of the RKE message 20 while beyond the communication range 26 of the system 10, and then have the RKE message transmitted and received after the operator 18 moves inside the communication range 26 with the nomadic device being carried in the operator's pocket. Such a configuration allows the operator 18 to ‘pre-arm’ the nomadic device so that the operator does not need to manually operate the nomadic device 16 to transmit the RKE message after moving inside the communication range 26.

While this invention has been described in terms of the preferred embodiments thereof, it is not intended to be so limited, but rather only to the extent set forth in the claims that follow.

We claim:

1. A nomadic device configured to communicate with a remote keyless entry (RKE) receiver of a vehicle, said nomadic device comprising:
a RKE transmitter configured to transmit autonomously a RKE message repetitiously in response to an initiation command.

2. The nomadic device in accordance with claim 1, wherein the RKE transmitter is configured to transmit autonomously the RKE message repetitiously at a repetition rate in response to the initiation command.

3. The nomadic device in accordance with claim 1, wherein the RKE transmitter is configured to transmit autonomously the RKE message repetitiously for a time interval in response to the initiation command.

4. The nomadic device in accordance with claim 1, wherein the nomadic device is configured to indicate that the RKE message is being transmitted.

5. The nomadic device in accordance with claim 1, wherein the nomadic device is a RKE key fob.

6. The nomadic device in accordance with claim 1, wherein the nomadic device is a personal communication device.

7. The nomadic device in accordance with claim 1, wherein the nomadic device further comprises a nomadic receiver configured to receive a message-received signal from the vehicle, whereupon the RKE transmitter ceases to transmit repetitiously the RKE message.

8. The nomadic device in accordance with claim 1, wherein the nomadic device further comprises a nomadic receiver configured to receive an identification-request signal from the vehicle, wherein the RKE transmitter is configured to transmit an identification code in response to the identification-request signal.

9. A remote keyless entry (RKE) system for a vehicle, said system comprising:
a RKE receiver configured to be installed on a vehicle;
a nomadic device equipped with an RKE transmitter configured to transmit autonomously a RKE message repetitiously in response to an initiation command.

10. The system in accordance with claim 9, wherein the RKE receiver is configured to transmit a message-received signal in response to receiving the RKE message.

11. The system in accordance with claim 9, wherein the RKE receiver is configured to transmit an identification-request signal in response to receiving the RKE message.
